(19) United States
(12) Patent Application Publication
(10) Pub. No.: US 2019/0087822 A1
(43) Pub. Date: Mar. 21, 2019

(54) SYSTEMS AND METHODS FOR ONBOARDING MERCHANTS IN REAL-TIME FOR PAYMENT PROCESSING

(71) Applicant: MASTERCARD INTERNATIONAL INCORPORATED, Purchase, NY (US)

(72) Inventors: Madhu Vasu, Foster City, CA (US); Rajasekaran Dhamodharan, Redwood City, CA (US); Mohammed Sadiq, Dubai (AE)

(21) Appl. No.: 16/135,963

(22) Filed: Sep. 19, 2018

Related U.S. Application Data
(60) Provisional application No. 62/560,584, filed on Sep. 19, 2017.

(51) Int. Cl. G06Q 20/40; G06K 19/06

(52) U.S. Cl. CPC G06Q 20/4016; G06K 19/06037

(57) ABSTRACT

An onboarding system for onboarding merchants in real-time using digital activity client (DAC) data is provided. The onboarding system includes at least one onboarding computing device configured to generate one or more risk score rules based on a first set of DAC data received from a DAC computing device and one or more acquirer parameters received from an acquirer computing device. The onboarding computer device is also configured to transmit the one or more risk score rules to the DAC computing device, and receive a risk score for a merchant from the DAC computing device. The onboarding computing device is further configured to compare the risk score to a risk score threshold, and determine, based on the comparison, whether to approve or decline the merchant to onboard in the onboarding system.

### CROSS REFERENCE TO RELATED APPLICATIONS

This application claims the benefit of and priority to U.S. Provisional Patent Application Ser. No. 62/560,584, filed Sep. 19, 2017, the content of which is hereby incorporated by reference in its entirety.

### BACKGROUND

This disclosure relates generally to onboarding merchants for processing electronic payment transactions and, more particularly, to systems and methods for onboarding merchants in real-time for processing electronic payment transactions over a network using digital activity client (DAC) data.

There are service providers that provide a variety of services to numerous consumers. These service providers utilize computer systems to provide these services. For example, in the financial industry, companies such as large banks, interchange networks, and payment networks provide certain financial services to consumers, merchants, third party companies, and other banks. Oftentimes, these service providers provide services that include receiving, processing, and storing financial data in computer systems managed by the service providers. In many cases, access to this financial data is restricted to certain approved consumers. Restricting access to such financial data provides at least some protection for the data. However, it also limits the potential uses of the data.

For example, an acquiring bank (or acquirer) is the bank or financial institution that facilitates processing of credit and/or debit card payments for products or services provided by a merchant. The term acquirer indicates that the bank accepts or acquires payment card transactions from merchants. In these known systems, the acquiring bank will contract with the merchant and will create a merchant account for the merchant at the acquiring bank. The arrangement is actually a line of credit and not a bank account. Under the agreement, the acquiring bank exchanges funds with issuing banks on behalf of the merchant, and pays the merchant for the net balance of their daily payment card activity: gross, which typically includes sales minus reversals, interchange fees, and acquirer fees.

Because this arrangement includes a line of credit, the acquiring bank is accepting certain risks. For example, the acquiring bank accepts the risk that the merchant will remain solvent over time. Thus, before an acquiring bank will approve a merchant for processing payment card transactions, the acquiring bank will require the merchant to complete an extensive application process where the merchant is required to provide very detailed financial information so that the acquiring bank can review it before making its decision about whether to underwrite the merchant. The process of submitting and reviewing the merchant application is very complicated and time consuming, and can prevent many smaller to mid-size merchants from even trying to register for such services. Because of these complexities in trying to navigate the payments ecosystem, many merchants and entrepreneurs have had to forego transacting business using payment card transactions. Furthermore, many smaller to mid-size merchants do not have the purchasing power and/or desire to use point-of-sale infrastructures that enable them to process payment card transactions using a payment card processing network in communication with their acquiring banks.

These merchants, who are essentially left out of the payment card processing industry, are unable to access many services relating to the payment card processing industry. In other words, these known systems, which are extremely complex, do not enable most small or mid-size merchants to easily use and register for processing payment card transactions and do not provide transaction management services to these merchants, which would enable these merchants to more efficiently operate their businesses.

### BRIEF DESCRIPTION

In one aspect, an onboarding system for onboarding merchants in real-time using digital activity client (DAC) data is provided. The onboarding system includes at least one onboarding computing device that includes a processor communicatively coupled to a memory and is configured to generate one or more risk score rules based on a first set of DAC data received from a DAC computing device and one or more acquirer parameters received from an acquirer computing device. The onboarding computing device is also configured to transmit the one or more risk score rules to the DAC computing device, and receive a risk score for a merchant from the DAC computing device, wherein the risk score is included in a second set of DAC data and is generated by the DAC computing device using the one or more risk score rules. The onboarding computing device is further configured to compare the risk score to a risk score threshold, and determine, based on the comparison, whether to approve or decline the merchant to onboard in the onboarding system.

In another aspect, a computer-implemented method for onboarding merchants in real-time using digital activity client (DAC) data is provided. The method is performed using an onboarding computing device that includes at least one processor in communication with at least one memory device. The method includes generating one or more risk score rules based on a first set of DAC data received from a DAC computing device and one or more acquirer parameters received from an acquirer computing device. The method also includes transmitting the one or more risk score rules to the DAC computing device, and receiving a risk score for a merchant from the DAC computing device, wherein the risk score is included in a second set of DAC data and is generated by the DAC computing device using the one or more risk score rules. The method further includes comparing the risk score to a risk score threshold, and determining, based on the comparison, whether to approve or decline the merchant to onboard in the onboarding system.

In yet another aspect, a non-transitory computer readable medium that includes executable instructions for onboarding merchants in real-time using digital activity client (DAC) data is provided. When the computer executable instructions are executed by an onboarding computing device that includes at least one processor in communication with at least one memory device, the computer executable instructions cause the onboarding computing device to generate one or more risk score rules based on a first set of DAC data received from a DAC computing device and one or more acquirer parameters received from an acquirer computing device. The computer executable instructions also cause the onboarding computing device to transmit the one or more risk score rules to the DAC computing device, and receive a risk score for a merchant from the DAC computing device, wherein the risk score is included in a second set of DAC data and is generated by the DAC computing device using the one or more risk score rules. The computer executable instructions further cause the onboarding computing device to compare the risk score to a risk score threshold, and determine, based on the comparison, whether to approve or decline the merchant to onboard in the onboarding system.

### BRIEF DESCRIPTION OF THE DRAWINGS

FIGS. 1-8 show example embodiments of the systems and methods described herein.

FIG. 1 is a schematic diagram illustrating a data flow 100 for onboarding merchants in real-time for processing electronic payment transactions over a network using digital activity client (DAC) data.

FIG. 2 is a simplified block diagram of an example system used for onboarding merchants in real-time using DAC data in accordance with an example embodiment of the present disclosure.

FIG. 3 is a schematic diagram illustrating an example multi-party payment processing system for enabling payment-by-card transactions.

FIG. 4 illustrates an example configuration of user system, such as a client system shown in FIG. 2, in accordance with an embodiment of the present disclosure.

FIG. 5 illustrates an example configuration of the server system shown in FIG. 2, in accordance with an embodiment of the present disclosure.

FIG. 6 is a flow diagram illustrating an example process for performing a purchase using a quick response (QR) code, which may be implemented utilizing the system shown in FIG. 2.

FIG. 7 is a flow diagram illustrating an example process for onboarding merchants in real-time using DAC data, which may be implemented utilizing the system shown in FIG. 2.

FIG. 8 shows a diagram of components of an example computing device that may be used in the system shown in FIG. 1 to onboard merchants in real-time using DAC data.

### DETAILED DESCRIPTION

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems utilizing an onboarding system for onboarding merchants in real-time for processing electronic payment transactions over a network, which includes setting up an account with an acquirer bank. As defined herein, real-time relates to the onboarding system processing data within a short period of time (e.g., from about milliseconds to minutes, or hours, as opposed to a matter of days) so that the data output and/or input is available virtually immediately. The onboarding system described herein includes at least one onboarding computing device.

The onboarding computing device may be in communication with at least one merchant computing device (e.g., a point-of-sale (POS) terminal, a smartphone, tablet, or any other computing device able to communicate with the onboarding computing device), a payment processor, at least one consumer computing device, at least one acquirer computing device, and at least one digital activity client (DAC) computing device. The DAC computing device is associated with a digital activity client (DAC), such as Facebook®, Google™, Microsoft®, or other type of DAC. The DACs provide services to merchants, such as advertisements and/or a platform where they may conduct payment transactions using debit card information (e.g., similar to transfer of funds) or at least have an online presence.

The onboarding computing device includes a processor in communication with a memory. The onboarding computing device is further in communication with at least one database for storing information, such as transaction data, digital activity client (DAC) data (e.g., first and second sets of DAC data), and acquirer data. The transaction data may include payment transactions initiated by a consumer using a payment device (e.g., a payment card, digital wallet, mobile payment, etc.) associated with a particular transaction processing network. The transaction data may also include, among other data points, data associated with the consumer and a merchant involved in the payment transaction. For example, transaction data may include one or more of: a consumer account data (e.g., a primary account number (PAN)), consumer biometric data, a merchant identifier, a merchant computing device identifier, a transaction amount, a time and date of the transaction, data descriptive of the purchase, a location of the transaction, an authorization message, and/or other data associated with the payment transaction. The DAC data may include merchant information, such as a merchant name (e.g., merchant business name, merchant first name, merchant last name, or the like), a merchant address (e.g., merchant street address, merchant city, merchant state, merchant county, merchant country, or the like), merchant email, merchant time zone, merchant profile picture from the DAC, merchant gender, a DAC merchant identifier, a risk score for a merchant, a DAC rating of a merchant, and other merchant information. The DAC data may also include DAC information, such as a DAC identifier, a DAC name, a DAC IP address, a DAC computing device identifier, a merchant consumer rating within the DAC, and other information associated with the DAC computing device transmitting the DAC data. The acquirer data may include a merchant identifier issued by the acquirer bank, an approval/rejection code, a quick response (QR) code, at least one acquirer parameter, or other information associated with a merchant registration with the acquirer bank.

In some embodiments, the DAC data is anonymized and aggregated (e.g., by the DAC computing device) prior to receipt by the onboarding computing device (i.e., no personally identifiable information (PII) is received by the onboarding computing device). The acquirer data may be also anonymized and aggregated (e.g., by the acquirer computing device) prior to receipt by the onboarding computing device (i.e., no personally identifiable information (PII) is received by the onboarding computing device). In other embodiments, the onboarding computing device may be configured to receive the DAC data, acquirer data, and/or transaction data that is not yet anonymized and/or aggregated, and thus may be configured to anonymize and aggregate the DAC data, acquirer data, and/or transaction data. In such embodiments, any PII received by the onboarding computing device is received and processed in an encrypted format, or is received with the consent of individuals with which the PII is associated. In situations in which the systems discussed herein collect personal information about individuals including users and/or merchants, or may make use of such personal information, individuals may be provided with an opportunity to control whether such information is collected or to control whether and/or how such information is used. In addition, certain data may be processed in one or more ways before it is stored or used, so that personally identifiable information is removed.

In the example embodiment, the DAC computing device is configured to collect a first set of DAC data from at least one merchant computing device and transmit such data to the onboarding computing device. The onboarding computing device uses the first set of DAC data and acquirer parameters provided by at least one acquirer computing device to generate data weights for data included in the first set of DAC data that corresponds to the merchant using the at least one merchant computing device. Data weights may be associated with a time period a merchant has held an account with the DAC, a merchant consumer rating within the DAC, a DAC rating of a merchant, a volume of transactions performed by a merchant using the DAC, a total amount transacted by the merchant using the DAC, whether a merchant has been involved in fraudulent activity, or any other data weight associated with the DAC data of the merchant. For example, the onboarding computing device may assign more weight to the fraudulent activity associated with a merchant compared to the total amount transacted by the merchant using the DAC. The onboarding computing device is further configured to generate risk score rules and a risk score threshold. The onboarding computing device generates the risk score rules and the risk score threshold by using the acquirer parameters, the generated weights, and other types of data that the DAC computing device may collect from merchant computing devices.

Once the risk score rules are generated, the onboarding computing device may transmit the risk score rules to the DAC computing device. By providing the risk score rules, the DAC and, more specifically, the DAC computing device does not have to provide confidential or personal merchant information to the onboarding computing device. However, in some embodiments, the DAC computing device provides this information to the onboarding computing device, so the onboarding computing device may apply the risk score rules and calculate the risk score. In the example embodiment, the DAC computing device computes a risk score for a merchant based upon the risk score rules, includes the risk score in a second set of DAC data, and transmits the second set of DAC data to the onboarding computing device for registration of the merchant with the onboarding system, and more specifically, with the acquirer bank. The onboarding computing device is also configured to store the data weights, the risk score threshold, the first set of DAC data, and second set of DAC data within a database in communication with the onboarding computing device.

In some embodiments, the DAC computing device may not compute a risk score for the merchant. In these embodiments, the DAC computing device collects the first set of DAC data, and transmits such data to the onboarding computing device. The onboarding computing device is configured to transmit the first set of DAC data to the acquirer computing device, which uses the first set of DAC data to determine whether to approve and onboard the merchant into the onboarding system.

In the example embodiment, the onboarding computing device is also configured to compare the risk score included in the second set of DAC data to the risk score threshold. If the risk score is higher than the risk score threshold (or otherwise the risk score satisfies the threshold for being risky), the onboarding computing device may decline, on behalf of the acquirer bank, the merchant registration with the acquirer bank. Upon rejection, the onboarding computing device may transmit a rejection response to the DAC computing device and/or at least one acquirer computing device associated with the acquirer bank. The onboarding computing device may also transmit the risk score and a reason the merchant was declined (e.g., one or more reasons why the risk score threshold was not satisfied) to the DAC computing device and/or the at least one acquirer computing device.

Conversely, if the risk score is lower than the risk score threshold (or otherwise the risk score satisfies the risk score threshold for being not risky), the onboarding computing device may approve the merchant registration with the acquirer bank. Upon approval, the onboarding computing device transmits the second set of DAC data to the acquirer computing device. In general, after approval by the onboarding computing device and upon receiving the second set of DAC data, the acquirer computing device approves the merchant registration and may perform a minimal Know Your Customer (KYC) check. In some countries, regulatory requirements may require merchants to complete the KYC check within a stipulated period of time (e.g., within 60 days). The disclosed system does not alter any such regulatory requirements. Rather, in these cases, the onboarding computing device would still approve the merchant, the acquirer would as well, and then the KYC check would be conducted after the approval by the acquirer. Merchants may not need to perform a minimal KYC at the time of registration. In some cases, the acquirer computing device may decline the merchant registration. These cases may include fraudulent activity associated with the merchant that was not captured by the DAC computing device. Once the merchant is approved by the acquirer computing device, the acquirer computing device generates a merchant identifier associated with an account created for the merchant.

In some embodiments, the merchant may be approved by multiple acquirer computing devices each associated with a different acquirer bank. In these embodiments, each acquirer computing device transmits an approval message to the onboarding computing device and, in response, the onboarding computing device generates, using the approval message from each acquirer computing device, a list of acquirer banks that have approved the merchant, and transmits the list to the DAC computing device. Then, the DAC computing device transmits the list to a merchant computing device associated with the merchant, along with instructions for the merchant computing device to display the list to the merchant. Once the merchant computing device displays the list to the merchant, the merchant may select one acquirer bank from the list and, in response, the merchant computing device transmits the selection, including at least an acquirer bank identifier associated with the selected acquirer bank, to the DAC computing device. Then, the DAC computing device transmits the selection to the onboarding computing device, which routes the selection, using the acquirer bank identifier, to an acquirer computing device associated with the selected acquirer bank. Once the acquirer computing device receives the selection, the acquirer computing device generates a merchant identifier associated with an account created for the merchant.

In certain embodiments, once the acquirer computing device approves the merchant or receives the selection, the acquirer computing device may perform further authentication of the merchant. For example, the acquirer computing device may transmit, via the onboarding computing device and the DAC computing device, a message (e.g., a one-time password (OTP)) to a merchant's phone in order to validate the phone number associated with the merchant's phone. Additionally or alternatively, the acquirer computing device may use another suitable method for performing further authentication of the merchant.

In some embodiments, the merchant account has a restrictive chargeback right. That is, the merchant account may only receive funds and limit funds to be withdrawn. By doing so, the risk of fraud is significantly mitigated. Subsequently, the acquirer computing device generates a QR code that includes the merchant identifier and data included in the DAC data. In the example embodiment, the acquirer computing device leaves the QR code by itself. That is, the acquirer computing device does not include the QR code in any other data, such as the acquirer data. In other embodiments, the acquirer computing device includes the QR code in the acquirer data and transmits the acquirer data to the onboarding computing device, which then transmits the acquirer data to the DAC computing device and/or the merchant computing device.

In the example embodiment, the acquirer computing device transmits the QR code to the onboarding computing device and, in response, the onboarding computing device transmits the QR code to the DAC computing device, which transmits the QR code to a merchant computing device associated with the merchant. The merchant may use the QR code to initiate transactions at the merchant computing device. The merchant may also print the QR code and paste the QR code in a physical location, such as a merchant store, so consumer computing devices may scan the QR code and initiate transactions with the merchant.

In some embodiments, once the QR code is scanned, the consumer computing device may prompt the consumer to provide one or more authentication criteria (e.g., a personal identification number (PIN) or biometric authentication) in order to proceed. In other embodiments, the authentication criteria are requested prior to scanning the QR code. In some embodiments, after the consumer computing device has captured the QR code (at a merchant's website, the merchant computing device, or the physical location), the consumer computing device prompts the consumer to enter the transaction amount of the purchase into the consumer computing device to initiate a payment card transaction for the purchase. In other embodiments, the QR code includes the transaction amount, and thus the consumer computing device does not prompt the consumer to enter the transaction amount. In such embodiments, the consumer computing device prompts the consumer to enter the transaction amount and enables the consumer to confirm the transaction amount by, for example, entering authentication criteria (e.g., a PIN or biometric data), or pressing an “Agree” or “Ok” button. The consumer computing device may use any other suitable features that enable the consumer to confirm the transaction amount. The consumer computing device also allows the consumer to disagree with the transaction amount by, for example, pressing a “Disagree” or “Cancel” button. The consumer computing device may use any other suitable features that enable the consumer to disagree with the transaction amount. In the example embodiment, an application in the consumer computing device generates transaction data including the transaction amount and transmits the transaction data to the acquirer computing device based upon the information in the QR code. The merchant computing device and the consumer computing device may notify the merchant and the consumer, respectively, that the purchase is complete or denied by displaying, for example, a “Successful Purchase” or “Denied Purchase” notification, respectively.

Once the payment card transaction is complete, the onboarding computing device transmits to the consumer computing device a notification of successful transaction completion. In some embodiments, the consumer may download to the consumer computing device a digital wallet, such as DAC application or a mobile banking application, to be able to capture the QR code. In other embodiments, the consumer accesses a website that includes the QR code, such as a merchant website, to capture the QR code.

The methods and systems described herein may be implemented using computer programming or engineering techniques including computer software, firmware, hardware, or any combination or subset thereof. As disclosed above, at least one technical problem with prior payment processing systems is that the systems require extremely large amounts of time to register and create an account for a merchant with an acquirer bank. The systems and methods described herein address this technical problem by generating one or more risk score rules by the onboarding computing device, transmitting the one or more risk score rules to the DAC computing device which applies to the one or more risk score rules to a first set of DAC data, generates a risk score for a merchant, includes the risk score in a second set of DAC data, and transmits the second set of DAC data to the onboarding computing for onboarding the merchant in real-time with an acquirer bank. Merchants, especially small merchants (e.g., micro merchants), are able to obtain an account with the acquirer bank and start performing transactions using that account in few seconds. Further, fraudulent activity is significantly mitigated by creating risk score rules that verify if a merchant is eligible to register with the acquirer bank.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as computing devices in the form of mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

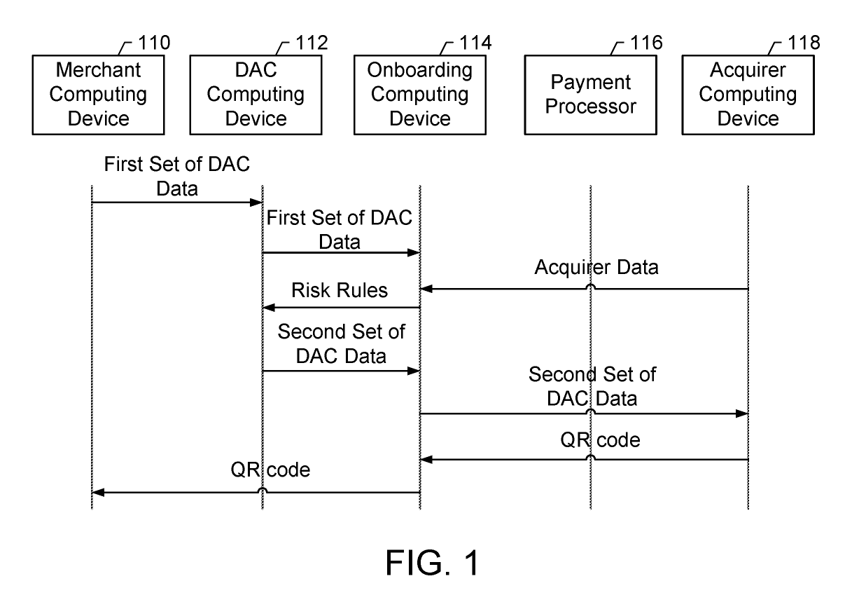

FIG. 1 is a schematic diagram illustrating a data flow 100 for onboarding merchants in real-time for processing electronic payment transactions over a network using digital activity client (DAC) data. In the example embodiment, data flow 100 is implemented using an onboarding system (not shown in FIG. 1) that includes a merchant computing device 110 associated with a merchant, a digital activity client (DAC) computing device 112 associated with a digital activity client (DAC), an onboarding computing device 114, a payment processor 116, and an acquirer computing device 118 associated with an acquirer bank. In the example embodiment, onboarding computing device 114 is configured to onboard merchants using DAC data provided by DAC computing device 112.

In the example embodiment, DAC computing device 112 is configured to collect a first set of DAC data from a merchant computing device 110 and transmit such data to onboarding computing device 114. Onboarding computing device 114 uses the first set of DAC data and acquirer parameters provided by at least one acquirer computing device 118 to generate data weights for data included in the first set of DAC data that corresponds to the merchant using merchant computing device 110, for example, data weights may be associated with a time period a merchant has held an account with the DAC, a merchant consumer rating within the DAC, a DAC rating of a merchant, a volume of transactions performed by a merchant using the DAC, a total amount transacted by the merchant using the DAC, whether a merchant has been involved in fraudulent activity, or any other data weight associated with the DAC data and DAC data of the merchant. For example, onboarding computing device 114 may assign more weight to the fraudulent activity associated with a merchant compared to the total amount transacted by the merchant using the DAC. Onboarding computing device 114 is further configured to generate risk score rules. Onboarding computing device 114 generates the risk score rules and the risk score threshold by using the acquirer parameters, the generated weights, and other types of data that DAC computing device 112 may collect from merchant computing devices 110.

Once the risk score rules are generated, onboarding computing device 114 may transmit the risk score rules to DAC computing device 112. By providing the rules, the DACs and, more specifically, DAC computing device 112 do not have to provide confidential or personal merchant information to onboarding computing device 114. However, in some embodiments, DAC computing device 112 provides this information to onboarding computing device 114, so onboarding computing device 114 may apply the risk score rules and calculate the risk score. In the example embodiment, DAC computing device 112 computes a risk score for a merchant based upon the risk score rules, includes the risk score in a second set of DAC data, and transmits the second set of DAC data to onboarding computing device 114 for registration of the merchant with the onboarding system, and more specifically, with the acquirer bank. Onboarding computing device 114 is also configured to store the data weights, the risk score threshold, the first set of DAC data, and the second set of DAC data within a database in communication with onboarding computing device 114.

In some embodiments, DAC computing device 112 may not compute a risk score for the merchant. In these embodiments, DAC computing device 112 collects the first set of DAC data and transmits such data to onboarding computing device 114. Onboarding computing device 114 is configured to transmit the first set of DAC data to the acquirer computing device 118, which uses the first set of DAC data to determine whether to approve and onboard the merchant.

Onboarding computing device 114 is also configured to compare the risk score included in the second set of DAC data to the risk score threshold. If the risk score is higher than the risk score threshold (or otherwise the risk score satisfies the risk score threshold for being risky), onboarding computing device 114 may decline, on behalf of the acquirer bank, the merchant registration with the acquirer bank. Upon rejection, onboarding computing device 114 may transmit a rejection response to DAC computing device 112 and/or at least one acquirer computing device 118 associated with the acquirer bank. Onboarding computing device 114 may also transmit the risk score and a reason the merchant was declined (e.g., a reason why the risk score threshold was not satisfied) to DAC computing device 112 and/or the at least one acquirer computing device 118.

Conversely, if the risk score is lower than the risk score threshold (or otherwise the risk score satisfies the risk score threshold for being not risky), onboarding computing device 114 may approve the merchant registration with the acquirer bank. Upon approval, onboarding computing device 114 transmits the second set of DAC data to acquirer computing device 118. In general, after approval by onboarding computing device 114 and upon receiving the second set of DAC data, acquirer computing device 118 approves the merchant registration and may perform a minimal Know Your Customer (KYC) check. In some countries, regulatory requirements may require merchants to complete the KYC check within a stipulated period of time (e.g., within 60 days). The disclosed system does not alter any such regulatory requirements. Rather, in these cases, onboarding computing device 114 would still approve the merchant, the acquirer would as well, and then the KYC check would be conducted after the approval by the acquirer. Merchants may not need to perform a minimal KYC at the time of registration. In some cases, acquirer computing device 118 may decline the merchant registration. These cases may include fraudulent activity associated with the merchant that was not captured by DAC computing device 112. Once the merchant is approved by acquirer computing device 118, acquirer computing device 118 generates a merchant identifier associated with an account created for the merchant.

In some embodiments, the merchant may be approved by multiple acquirer computing devices 118 each associated with a different acquirer bank. In these embodiments, each acquirer computing device 118 transmits an approval message to onboarding computing device 114 and, in response, onboarding computing device 114 generates, using the approval message from each acquirer computing device 118, a list of acquirer banks that have approved the merchant, and transmits the list to DAC computing device 112. Then, DAC computing device 112 transmits the list to merchant computing device 110, along with instructions for merchant computing device 110 to display the list to the merchant. Once merchant computing device 110 displays the list to the merchant, the merchant may select one acquirer bank from the list and, in response, merchant computing device 110 transmits the selection, including at least an acquirer bank identifier associated with the selected acquirer bank, to DAC computing device 112. Then, DAC computing device 112 transmits the selection to onboarding computing device 114, which routes the selection, using the acquirer bank identifier, to an acquirer computing device 118 associated with the selected acquirer bank. Once acquirer computing device 118 receives the selection, acquirer computing device 118 generates a merchant identifier associated with an account created for the merchant.

In certain embodiments, once acquirer computing device 118 approves the merchant or receives the selection, acquirer computing device 118 may perform further authentication of the merchant. For example, acquirer computing device 118 may transmit, via onboarding computing device 114 and/or DAC computing device 112, a message (e.g., a one-time password (OTP)) to a merchant's device (e.g., a merchant's phone and/or merchant computing device 110) in order to validate the phone number associated with the merchant. Additionally or alternatively, acquirer computing device 118 may use another suitable method for performing further authentication of the merchant.

In some embodiments, the merchant account has a restrictive chargeback right. That is, the merchant account may only receive funds and limit funds to be withdrawn. By doing so, the risk of fraud is significantly mitigated. Subsequently, acquirer computing device 118 generates a QR code that includes the merchant identifier and data included in the second set of DAC data. In the example embodiment, acquirer computing device 118 leaves the QR code by itself. That is, acquirer computing device 118 does not include the QR code in any other data, such as the acquirer data. In other embodiments, acquirer computing device 118 includes the QR code in the acquirer data and transmits the acquirer data to onboarding computing device 114, which then transmits the acquirer data to DAC computing device 112 and/or merchant computing device 110.

In the example embodiment, acquirer computing device 118 transmits the QR code to onboarding computing device 114 and, in response, onboarding computing device 114 transmits the QR code to DAC computing device 112, which transmits the QR code to a merchant computing device associated with the merchant. The merchant may use the QR code to initiate transactions at merchant computing device 110. The merchant may also print the QR code and paste the QR code in a physical location, such as a merchant store, so consumer computing devices may scan the QR code and initiate transactions with the merchant. After a consumer computing device has captured the QR code (at a merchant's website, merchant computing device 110, or the physical location), a consumer associated with the consumer computing device simply requires to enter the amount of the purchase and an authentication associated with the consumer computing device (e.g., a personal identification number (PIN), or biometric authentication) to initiate and complete such purchase, as explained more in detail below. Once the purchase is complete, onboarding computing device 114 transmits to the consumer computing device a notification of successful transaction completion. In some embodiments, the consumer may download to the consumer computing device a digital wallet, such as DAC application or a mobile banking application, to be able to capture the QR code. In other embodiments, the consumer accesses a website that includes the QR code, such as a merchant website, to capture the QR code.

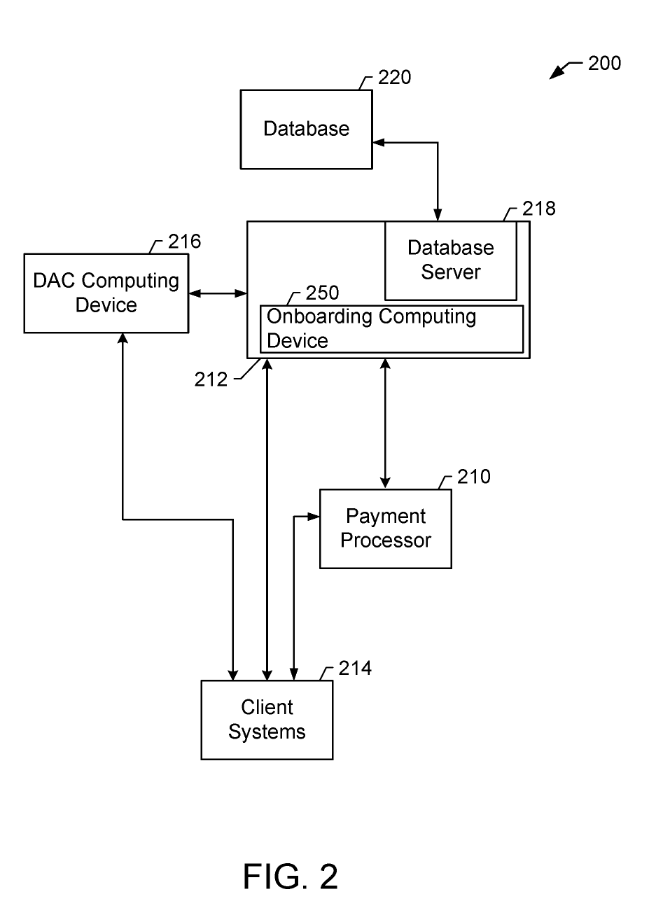

FIG. 2 is a simplified block diagram of an onboarding system 200 for onboarding merchants in real-time for processing electronic payment transactions over a network using digital activity client (DAC) data in accordance with one example embodiment of the present disclosure. Onboarding system 200 may be implemented in the performance of payment-by-card transactions received as part of processing consumer transactions. In an example embodiment, onboarding system 200 is a payment processing system that includes an onboarding computing device 250 (similar to onboarding computing device 114 as illustrated in FIG. 1) configured to onboard merchants using digital activity client (DAC) data.

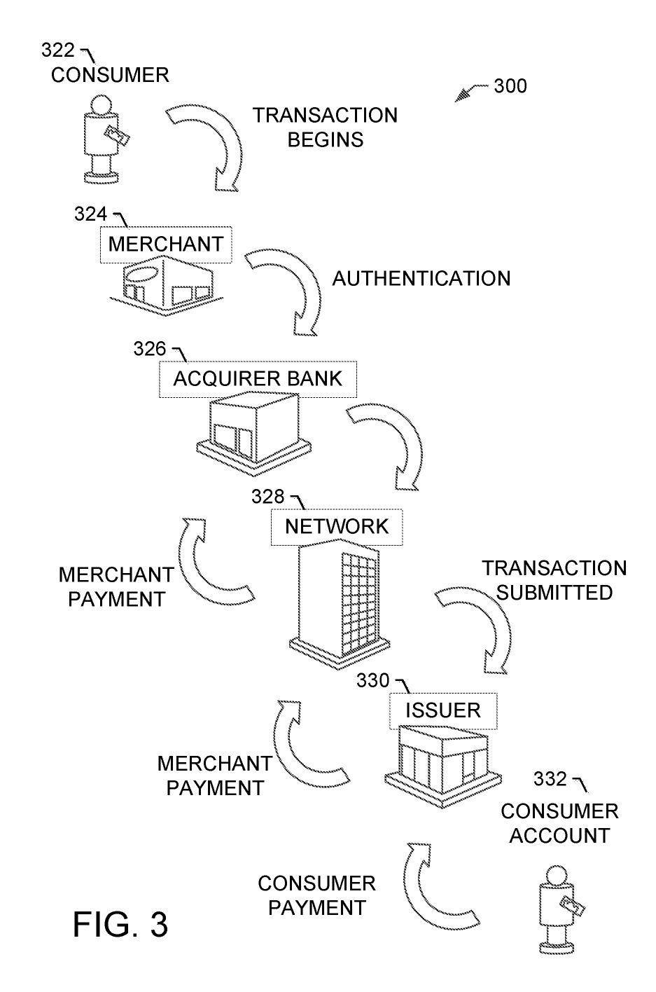

In the example embodiment, onboarding system 200 includes a server system 212, client systems 214, and at least one digital activity client (DAC) computing device 216 (similar to DAC computing device 112, as illustrated in FIG. 1). In the example embodiment, client systems 214 and DAC computing device 216 are similar computing devices. In the example embodiment, client systems 214 include computing devices configured to implement a web browser or a software application, which enables client systems 214 to access other computing devices, such as other client systems 214 and/or server system 212, using the Internet. Client systems 214 may be communicatively coupled to the Internet through many interfaces including, but is not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Alternatively, client systems 214 include any device capable of accessing the Internet including, but is not limited to, a desktop computer, a laptop computer, a personal digital assistant (PDA), a cellular phone, a smartphone, a tablet, a phablet, or other web-based connectable equipment. In the example embodiment, client systems 214 include merchant computing device 110 (shown in FIG. 1) associated with merchant 324 (shown in FIG. 3) and at least one consumer computing device (not shown) associated with consumer 322 (shown in FIG. 3). Client systems 214 may also include acquirer computing device 118 (shown in FIG. 1) associated with acquirer bank 326 (shown in FIG. 3), and/or at least one issuer computing device (not shown) associated with issuer bank 330 (shown in FIG. 3).

In one embodiment, server system 212 includes a database server 218 that is communicatively coupled to a database 220 for storing data. In an exemplary embodiment, database 220 stores transaction information from a plurality of consumers 322 and/or merchants 324 and paths based on the individual transactions. According to the exemplary embodiment, database 220 is disposed remotely from server system 212. In other embodiments, database 220 is decentralized, or may be a portion of server system 212. In the exemplary embodiment, a user (not shown) is able to access database 220 through client systems 214 and/or DAC computing device 216 by logging onto server system 212. In the example embodiment, server system 212 may be associated with payment processor 210. Payment processor may be associated with interchange network 328 (shown in FIG. 3).

Client systems 214 may include merchant computing device 110, as described above, that may be communicatively coupled with server system 212 directly and/or through payment processor 210 and/or DAC computing device 216. Merchant computing device 110 may also be communicatively coupled with server system 212 through payment processing system 300 (shown in FIG. 3). Merchant computing device 110 may include, without limitation, machines that accept card swipes, online payment portals, digital wallet payments, or stored payment card numbers for recurring transactions.

In the example embodiment, server system 212 is associated with a financial transaction interchange network, such as interchange network 328 and is also referred to as an interchange computer system. In some embodiments, server system 212 is used for processing transaction data and analyzing such data to identify fraudulent transactions and onboard merchant to the onboarding system 200. In one embodiment, at least one of client system 214 includes a computer system (e.g., at least one issuer computing device) associated with an issuer of a transaction payment card. Accordingly, server system 212 and client systems 214 may be utilized to process transaction data relating to purchases consumer 322 makes utilizing a transaction card processed by interchange network 328 and issued by the associated issuer bank 330. In the exemplary embodiment, at least one client system 314 may be associated with consumer 322 seeking to register, access information, or process a transaction with at least one of interchange network 328, issuer bank 330, and/or merchant 324.

FIG. 3 is a schematic diagram illustrating an example multi-party payment processing system 300 for onboarding merchants in real-time using digital activity client (DAC) data. Embodiments described herein may relate to a transaction card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, N.Y.).

As described with respect to payment processing system 300, a financial institution called the “issuer” issues a transaction card or electronic payments account identifier, such as a credit card or debit card, to a cardholder or consumer 322, who uses the transaction card to tender payment for a purchase from a merchant 324. To accept payment with the transaction card, merchant 324 must normally establish an account with a financial institution that is part of the financial payment system. This financial institution is usually called the “merchant bank,” the “acquirer bank,” or the “acquirer.” When consumer 322 tenders payment for a purchase with a transaction card, merchant 324 requests authorization from an acquirer bank 326 for the amount of the purchase. The request may be performed over the telephone, but is usually performed through the use of a point-of-sale (POS) terminal or a merchant computing device (e.g., merchant computing device 110, as illustrated in FIG. 1), which reads consumer's 322 account information from a magnetic stripe, a chip, or embossed characters on the transaction card and communicates electronically with the transaction processing computers of acquirer bank 326. Alternatively, acquirer bank 326 may authorize a third party to perform transaction processing on its behalf. In this case, the POS terminal or merchant computing device will be configured to communicate with the third party. Such a third party is usually called a “merchant processor,” an “acquiring processor,” or a “third party processor.”

Using an interchange network 328 associated with payment processor 116 (shown in FIG. 1), computers of acquirer bank 326 (e.g., acquirer computing device 118, as illustrated in FIG. 1) or merchant computing device 110 will communicate with computing devices of an issuer bank 330 to determine whether consumer account 332 associated with consumer 322 is in good standing and whether the purchase is covered by consumer account 332 available credit line. Based on these determinations, the request for authorization will be declined or accepted. If the request is accepted, an authorization code is issued to merchant 324.

When a request for authorization is accepted, the available credit line of consumer account 332 is decreased. Normally, a charge for a payment card transaction is not posted immediately to consumer account 332 because bankcard associations, such as Mastercard International Incorporated®, have promulgated rules that do not allow merchant 324 to charge, or “capture,” a transaction until goods are shipped or services are delivered. However, with respect to at least some debit card transactions, a charge may be posted at the time of the transaction. When merchant 324 ships or delivers the goods or services, merchant 324 captures the transaction by, for example, appropriate data entry procedures on the POS terminal or the merchant computing device. This may include bundling of approved transactions daily for standard retail purchases. If consumer 322 cancels a transaction before it is captured, a “void” is generated. If consumer 322 returns goods after the transaction has been captured, a “credit” is generated. Interchange network 328 and/or issuer bank 330 stores the transaction card information, such as a category of merchant, a merchant identifier, a location where the transaction was completed, amount of purchase, and date and time of the transaction in a database, such as database 220 (shown in FIG. 2).

After a purchase has been made, a clearing process occurs to transfer additional transaction data related to the purchase among the parties to the transaction, such as acquirer bank 326, interchange network 328, and issuer bank 330. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by issuer bank 330, consumer account 332 is decreased. Normally, a charge is posted immediately to consumer account 332. Issuer bank 330 then transmits the approval to the acquiring processor for distribution of goods/services or information, or cash in the case of an automated teller machine (ATM).

After a transaction is authorized and cleared, the transaction is settled among merchant 324, acquirer bank 326, and issuer bank 330. Settlement refers to the transfer of financial data or funds among acquirer bank 326, issuer bank 330, and merchant's 324 account related to the transaction. Usually, transactions are captured and accumulated into a “batch,” which is settled as a group. More specifically, a transaction is typically settled between issuer bank 330 and interchange network 328, and then between interchange network 328 and acquirer bank 326, and then between acquirer bank 326 and merchant 324.

In some embodiments, consumer 322 registers one or more payment cards with a digital wallet. Having done this, consumer 322 can interact with a participating online merchant 324. At the check-out stage, online merchant 324 displays a button on the merchant website which consumer 322 can click on in order to make a payment using the consumer 322 digital wallet. Online merchant 324 then redirects consumer 322 to a “switch” operated by interchange network 328. Using a cookie located on a consumer computing device, the “switch” is able to determine which wallet-hosting server hosts a wallet associated with consumer 322. The switch then establishes a connection between the consumer computing device and the appropriate wallet-hosting system, which presents consumer 322 with a sign-in page (e.g., as a pop-up window), where there is an authentication process (e.g., entry of a pre-agreed password). This log-in process may use the same login credentials (e.g., password) which consumer 322 also uses to obtain access to other online banking activities.

The wallet-hosting system then securely transfers consumer 322 payment information to online merchant's 324 domain. Merchant's 324 domain submits consumer's 322 payment information to acquirer bank 326 for a separate authorization process in which the acquiring domain communicates with the issuer bank 330 to ask the bank to authorize the transaction. Thus, consumer 322 is not required to enter their card details (except at the stage of initially registering with the wallet-hosting system), and the online transaction process is streamlined with only a single redirection, and consistent branding for the entire payment process, irrespective of online merchant 324.

In some embodiments, a unique identifier is provided to consumer 322. The unique identifier is different from the number associated with consumer account 332. In these embodiments, interchange network 328 stores the unique identifier in database 220 along with consumer account 332. When interchange network 328 receives the unique identifier, interchange network 328 determines the associated consumer account 332 and uses that information in processing the payment transaction.

In the example embodiment, when consumer 322 completes selecting the goods or services that he or she desires to purchase, consumer 322 scans a merchant quick response (QR) code using a consumer computing device. In some embodiments, once the QR code is scanned, the consumer computing device may prompt consumer 322 to provide one or more authentication criteria (e.g., a personal identification number (PIN), or biometric authentication) in order to proceed. In other embodiments, the authentication criteria are requested prior to scanning the QR code. After the consumer computing device has captured the QR code (e.g., at merchant's 324 website, the POS terminal, the merchant computing device, or merchant's 324 physical location), consumer 322 simply enters the amount of the purchase (e.g., the payment card transaction amount) into the consumer computing device to initiate a payment card transaction for the purchase.

After the authentication criteria is met, the consumer computing device prompts consumer 322 one or more payment credentials that consumer 322 may select. Consumer 322 selects one of the payment credentials and enters the transaction amount for the purchase. In some embodiments, the QR code includes the transaction amount, and thus the consumer computing device does not prompt consumer 322 to enter the transaction amount. In such embodiments, the consumer computing device prompts consumer 322 to enter the transaction amount and enables consumer 322 to confirm the transaction amount by, for example, entering authentication criteria (e.g., a PIN or biometric data), or pressing an “Agree” or “Ok” button. The consumer computing device may use any other suitable features that enable consumer 322 to confirm the transaction amount. The consumer computing device also allows consumer 322 to disagree with the transaction amount by, for example, pressing a “Disagree” or “Cancel” button. The consumer computing device may use any other suitable features that enable consumer 322 to disagree with the transaction amount. In the example embodiment, an application in the consumer computing device generates transaction data including the transaction amount of the purchase and transmits the transaction data to acquirer computing device 118 associated with acquirer bank 326 based upon the information in the QR code.

Acquirer computing device 118 receives the transaction data through interchange network 328, performs checks on the transaction data, and may transmit the transaction data back to interchange network 328 for domain control validations and de-tokenization of the transaction data by interchange network 328. Interchange network 328 may also perform PIN/shared secret for the authorization message included in the transaction data. The PIN/shared secret is a form of authentication where consumer 322 verifies his or her identity for the payment transaction. The PIN/shared secret may be a 4-8 digit PIN value known by consumer 322 and established using a credentials management system associated with onboarding computing device 114 (shown in FIG. 1) during onboarding of merchant 324.

Interchange network 328 transmits the authorization message to an issuer computing device associated with issuer bank 330. The issuer computing device, in response to the authorization message, generates an authorization response. The issuer computing device transmits the authorization response to interchange network 328. Interchange network 328 transmits the authorization response to acquirer bank 326, which transmits the authorization response in the form of an approve or decline notification to merchant computing device 110 associated with merchant 324 and to the consumer computing device associated with consumer 322. Merchant computing device 110 and the consumer computing device may notify merchant 324 and consumer 322, respectively, that the purchase is complete or denied by displaying the authorization response in the form of, for example, a “Successful Purchase” or “Denied Purchase” notification, respectively.

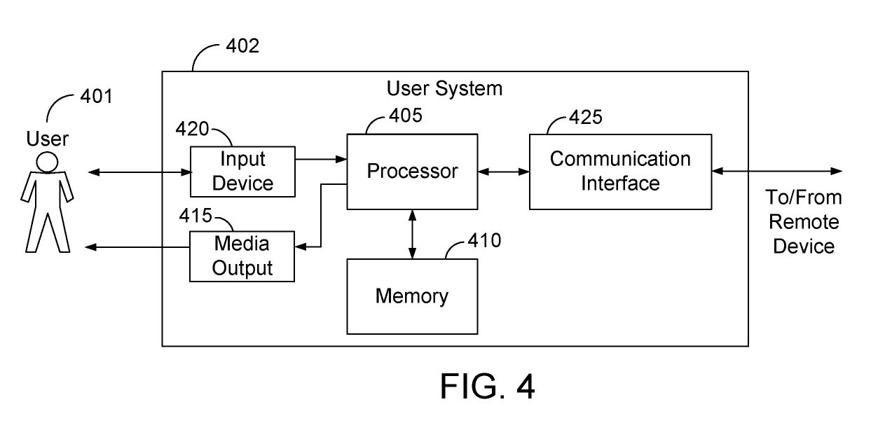

FIG. 4 illustrates an example configuration of a user system 402, such as client systems 214 (shown in FIG. 2) configured to transmit data to onboarding computing device 114 (shown in FIG. 1) and/or server system 212 (shown in FIG. 2). User system 402 may include, but is not limited to, client systems 214. In the example embodiment, user system 402 includes a processor 405 for executing instructions. In some embodiments, executable instructions are stored in a memory 410. Processor 405 may include one or more processing units, for example, a multi-core configuration. Memory 410 is any device allowing information such as executable instructions and/or written works to be stored and retrieved. Memory 410 may include one or more computer readable media.

User system 402 also includes at least one media output component 415 for presenting information to user 401. User 401 may include, but is not limited to, consumer 322 and merchant 324 (both shown in FIG. 3). Media output component 415 is any component capable of conveying information to user 401. For example, media output component 415 may be a display component configured to display component lifecycle data in the form of reports, dashboards, communications, and the like. In some embodiments, media output component 415 includes an output adapter such as a video adapter and/or an audio adapter. An output adapter is operatively coupled to processor 405 and operatively connectable to an output device, such as a display device, a liquid crystal display (LCD), organic light emitting diode (OLED) display, or “electronic ink” display, or an audio output device, a speaker or headphones.

In some embodiments, user system 402 includes an input device 420 for receiving input from user 401. Input device 420 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, or the like. A single component, such as a touch screen, may function as both an output device of media output component 415 and input device 420. A single component, such as a touch screen, may function as both an output device of media output component 415 and input device 420. User system 402 may also include a communication interface 425, which is communicatively connectable to a remote device such as server system 212. Communication interface 425 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory 410 are, for example, computer readable instructions for providing a user interface to user 401 via media output component 415 and, optionally, receiving and processing input from input device 420. A user interface may include, among other possibilities, a web browser, and a client application. Web browsers enable users, such as user 401, to display and interact with media and other information typically embedded on a web page or a website from server system 212 and/or onboarding computing device 114. A client application allows user 401 to interact with an application from server system 212 and/or onboarding computing device 114.

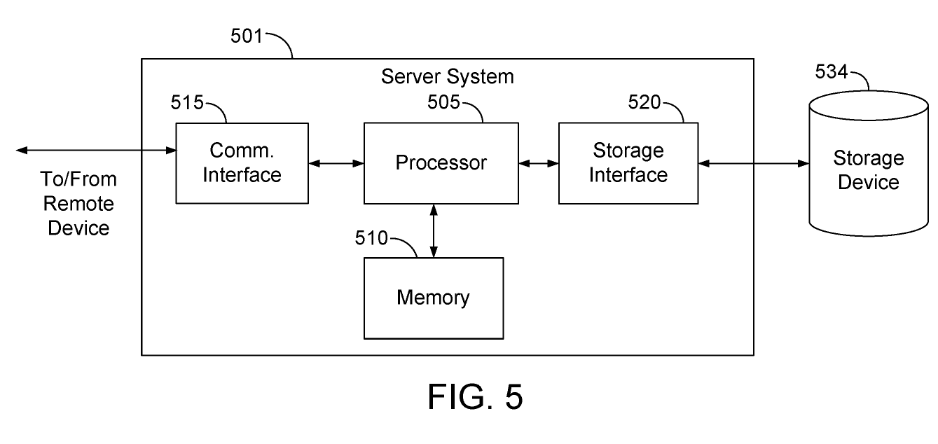

FIG. 5 illustrates an example configuration of a server system 501 such as the server system 212 (shown in FIG. 2) that includes onboarding computing device 114 (shown in FIG. 1). Server system 501 may include, but is not limited to, database server 218 (shown in FIG. 2) and/or onboarding computing device 114. In some embodiments, server system 501 is similar to server system 212.

Server system 501 includes a processor 505 for executing instructions. Instructions may be stored in a memory 510, for example. Processor 505 may include one or more processing units (e.g., in a multi-core configuration) for executing instructions. The instructions may be executed within a variety of different operating systems on the server system 501, such as UNIX, LINUX, Microsoft Windows®, etc. More specifically, the instructions may cause various data manipulations on data stored in storage device 534 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 505 is operatively coupled to a communication interface 515 such that server system 501 is capable of communicating with a remote device, such as a user system or another server system 501. For example, communication interface 515 may receive communications from client systems 214 via a plurality of network connections, as illustrated in FIG. 2.

Processor 505 may also be operatively coupled to a storage device 534. Storage device 534 is any computer-operated hardware suitable for storing and/or retrieving data. In some embodiments, storage device 534 is integrated in server system 501. In other embodiments, storage device 534 is external to server system 501 and is similar to database 220 (shown in FIG. 2). For example, server system 501 may include one or more hard disk drives as storage device 534. In other embodiments, storage device 534 is external to server system 501 and may be accessed by a plurality of server systems 501. For example, storage device 534 may include multiple storage units such as hard disks or solid state disks in a redundant array of inexpensive disks (RAID) configuration. Storage device 534 may include a storage area network (SAN) and/or a network attached storage (NAS) system.

In some embodiments, processor 505 is operatively coupled to storage device 534 via a storage interface 520. Storage interface 520 is any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Memory 510 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

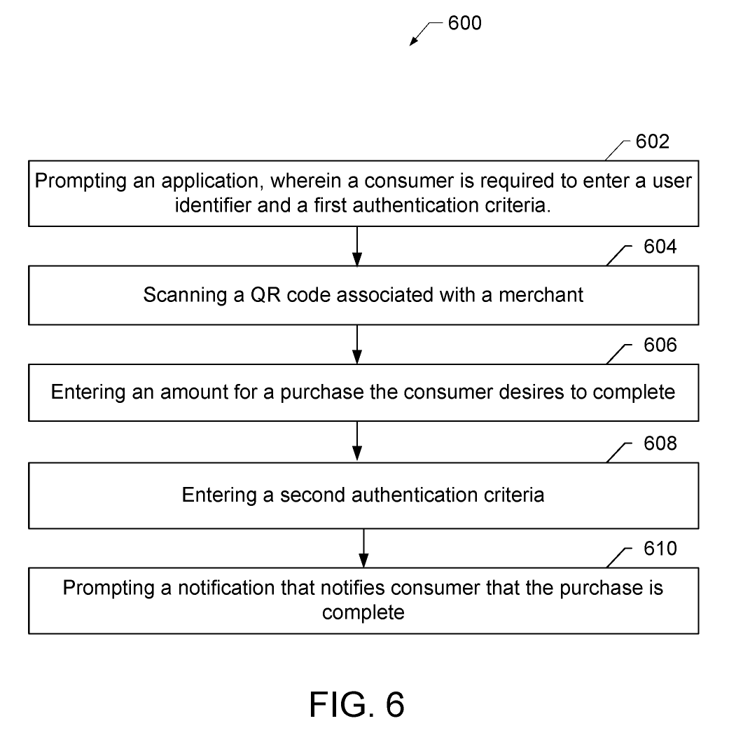

FIG. 6 is an example flow diagram illustrating a method flow 600 by which at least one consumer computing device enables consumer 322 (shown in FIG. 3) to use an application in the consumer computing device in order to complete a purchase. Method 600 includes prompting 602 an application, wherein consumer 322 is required to enter a consumer identifier and a first authentication criteria. Method 600 also includes scanning 604 a QR code associated with a merchant and entering 606 an amount for a purchase consumer 322 desires to complete. Method 600 further includes entering 608 a second authentication criteria and prompting 610 a notification that notifies consumer 322 that the purchase is complete.

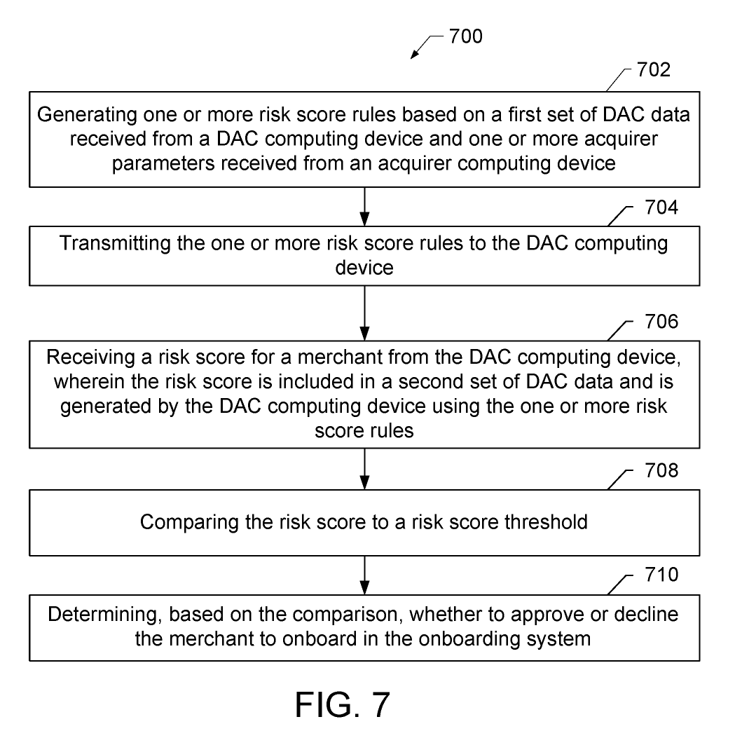

FIG. 7 is an example flow diagram illustrating a method flow 700 by which onboarding system 200 (shown in FIG. 2) including at least one onboarding computing device 114 (shown in FIG. 1) onboards merchants in real-time using digital activity client (DAC) data. Method 700 includes generating 702 one or more risk score rules based on a first set of DAC data received from a digital activity client (DAC) computing device 112 (shown in FIG. 1) and one or more acquirer parameters received from an acquirer computing device 118 (shown in FIG.1). Method 700 also includes transmitting 704 the one or more risk score rules to DAC computing device 112, and receiving 706 a risk score for a merchant 324 (shown in FIG. 3), wherein the risk score is included in a second set of DAC data and is generated by DAC computing device 112 using the one or more risk score rules. Method 700 further includes comparing 708 the risk score to a risk score threshold, and determining 710, based on the comparison, whether to approve or decline the merchant to onboard in the onboarding system.

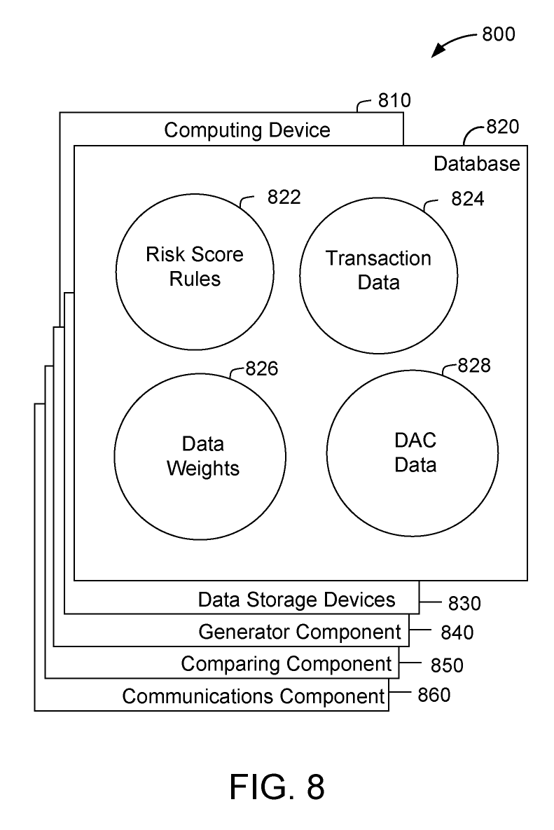

FIG. 8 is a diagram 800 of components of one or more example computing devices that may be used in onboarding system 200 shown in FIG. 2. In some embodiments, computing device 810 is similar to onboarding computing device 114 (shown in FIG. 1). Database 820 may be coupled with several separate components within computing device 810, which perform specific tasks. In this embodiment, database 820 includes risk score rules 822, transaction data 824, data weights 826, and DAC data 828. In some embodiments, database 820 is similar to database 220 (shown in FIG. 2).

Computing device 810 includes database 820, as well as data storage devices 830 for storing data within database 820. Computing device 810 also includes a generator component 840 for generating 702 (shown in FIG. 7) one or more risk score rules based on a first set of DAC data received from a digital activity client (DAC) computing device 112 (shown in FIG. 1) and one or more acquirer parameters received from an acquirer computing device 118 (shown in FIG.1). Computing device 810 also includes a comparing component 850 for comparing 708 (shown in FIG. 7) the risk score to a risk score threshold. Computing device 810 further includes a communications component 860 for transmitting 704 (shown in FIG. 7) the one or more risk score rules to DAC computing device 112, receiving 706 (shown in FIG. 7) a risk score for a merchant 324 (shown in FIG. 3), transmitting 712 (shown in FIG. 7) a decline message to DAC computing device 112, and transmitting 714 (shown in FIG. 7) the risk score to acquirer computing device 118.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible and fast system for various aspects of fraud analysis for registration of merchants with acquirer banks. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the onboarding computing device are described herein as including general processing and memory devices, it should be understood that the onboarding computing device is a specialized computer configured to perform the steps described herein for onboarding merchants in real-time using digital activity client (DAC) data.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. An onboarding system for onboarding merchants in real-time using digital activity client (DAC) data, the onboarding system comprising an onboarding computing device, the onboarding computing device comprising a processor communicatively coupled to a memory, the onboarding computing device configured to:
generate one or more risk score rules based on a first set of DAC data received from a DAC computing device and one or more acquirer parameters received from an acquirer computing device;
transmit the one or more risk score rules to the DAC computing device;
receive a risk score for a merchant from the DAC computing device, wherein the risk score is included in a second set of DAC data and is generated by the DAC computing device using the one or more risk score rules;
compare the risk score to a risk score threshold; and
determine, based on the comparison, whether to approve or decline the merchant to onboard in the onboarding system.

2. The onboarding system of claim 1, wherein the onboarding computing device is further configured to generate one or more weights based on the one or more acquirer parameters and the first set of DAC data.

3. The onboarding system of claim 2, wherein the onboarding computing device is further configured to generate the risk score threshold based on the one or more acquirer parameters and the generated one or more weights.

4. The onboarding system of claim 1, wherein the onboarding computing device is further configured to:
determine the risk score is lower than the risk score threshold; and
transmit an approval message to the DAC computing device.

5. The onboarding system of claim 4, wherein the onboarding computing device is further configured to transmit the second set of DAC data to the acquirer computing device after determining the risk score is lower than the risk score threshold.

6. The onboarding system of claim 1, wherein the onboarding computing device is further configured to:
receive a plurality of approval messages, wherein each of the plurality of approval messages is received from different acquirer banks, and wherein each of the different acquirer banks is associated with at least one acquirer computing device;
generate a list including the different acquirer banks; and
transmit the list to the DAC computing device.

7. The onboarding system of claim 1, wherein the onboarding computing device is further configured to:
receive a QR code from the acquirer computing device, the QR code operable to initiate a payment card transaction, at the merchant, by a consumer using a consumer computing device; and
transmit the QR code to a merchant computing device.

8. The onboarding system of claim 1, wherein the onboarding computing device is further configured to:
determine the risk score is higher than the risk score threshold;
transmit a decline message to the DAC computing device; and
transmit the risk score to the acquirer computing device.

9. A computer-implemented method for onboarding merchants in real-time using digital activity client (DAC) data, said method implemented using an onboarding system including an onboarding computing device in communication with a memory, said method comprising:
generating, by the onboarding computing device, one or more risk score rules based on a first set of DAC data received from a DAC computing device and one or more acquirer parameters received from an acquirer computing device;
transmitting, by the onboarding computing device, the one or more risk score rules to the DAC computing device;
receiving, by the onboarding computing device, a risk score for a merchant from the DAC computing device, wherein the risk score is included in a second set of DAC data and is generated by the DAC computing device using the one or more risk score rules;
comparing, by the onboarding computing device, the risk score to a risk score threshold; and
determining, by the onboarding computing device based on the comparison, whether to approve or decline the merchant to onboard in the onboarding system.

10. The method of claim 9 further comprising generating, by the onboarding computing device, one or more weights based on the one or more acquirer parameters and the first set of DAC data.

11. The method of claim 9 further comprising generating, by the onboarding computing device, the risk score threshold based on the one or more acquirer parameters and the generated one or more weights.

12. The method of claim 9 further comprising:
determining, by the onboarding computing device, the risk score is lower than the risk score threshold; and
transmitting, by the onboarding computing device, an approval message to the DAC computing device.

13. The method of claim 12 further comprising transmitting, by the onboarding computing device, the second set of DAC data to the acquirer computing device after determining the risk score is lower than the risk score threshold.

14. The method of claim 9 further comprising:
receiving, by the onboarding computing device, a plurality of approval messages, wherein each of the plurality of approval messages is received from different acquirer banks, and wherein each of the different acquirer banks is associated with at least one acquirer computing device;
generating, by the onboarding computing device, a list including the different acquirer banks; and
transmitting, by the onboarding computing device, the list to the DAC computing device.

15. The method of claim 9 further comprising:
receiving, by the onboarding computing device, a QR code from the acquirer computing device, the QR code operable to initiate a payment card transaction, at the merchant, by a consumer using a consumer computing device; and
transmitting, by the onboarding computing device, the QR code to a merchant computing device.

16. The method of claim 9 further comprising:
determining, by the onboarding computing device, the risk score is higher than the risk score threshold;
transmitting, by the onboarding computing device, a decline message to the DAC computing device; and
transmitting, by the onboarding computing device, the risk score to the acquirer computing device.

17. A non-transitory computer-readable storage media having computer-executable instructions embodied thereon, wherein when executed by an onboarding computing device having at least one processor coupled to at least one memory device, the computer-executable instructions cause the processor to:
generate one or more risk score rules based on a first set of DAC data received from a DAC computing device and one or more acquirer parameters received from an acquirer computing device;
transmit the one or more risk score rules to the DAC computing device;
receive a risk score for a merchant from the DAC computing device, wherein the risk score is included in a second set of DAC data and is generated by the DAC computing device using the one or more risk score rules;
compare the risk score to a risk score threshold; and
determine, based on the comparison, whether to approve or decline the merchant to onboard in the onboarding system.

18. The computer-executable instructions of claim 17 further cause the processor to generate one or more weights based on the one or more acquirer parameters and the first set of DAC data.

19. The computer-executable instructions of claim 17 further cause the processor to generate the risk score threshold based on the one or more acquirer parameters and the generated one or more weights.

20. The computer-executable instructions of claim 17 further cause the processor to:
receive a QR code from the acquirer computing device, the QR code operable to initiate a payment card transaction, at the merchant, by a consumer using a consumer computing device; and
transmit the QR code to a merchant computing device.
